(19) United States
(12) Patent Application Publication
(10) Pub. No.: US 2012/0287047 A1
(43) Pub. Date: Nov. 15, 2012

(54) Method and apparatus to control computer time out

(76) Inventor: William L. White, Phoenix, AZ (US)

(21) Appl. No.: 13/199,262

(22) Filed: Aug. 24, 2011

Related U.S. Application Data
(60) Provisional application No. 61/518,634, filed on May 9, 2011.

(51) Int. Cl. G06F 3/033

(52) U.S. Cl. 345/166

(57) ABSTRACT

A method controls time-outs during a computer program. The method comprises the step of providing a computer including a display screen; a program on the computer; an optical mouse in communication with the computer to manipulate a cursor on the display screen during operation of the program; a landing shaped and dimensioned to receive the optical mouse in a selected position on the landing; and, a movable element in the landing positioned to be sensed, when the element moves, by the optical mouse when the mouse is in the selected position on the landing. The method also comprises the steps of operating the computer program; positioning the mouse on the landing in the selected position; and, moving the movable element to be sensed by the optical mouse.

This application claims priority based on U.S. Provisional Patent Application Ser. No. 61/518,634 filed May 9, 2011.

This invention relates to computers.

More particularly, the invention relates to computer time-outs.

A computer time out is an interrupt signal generated by a program, computer, or other device that has waited a certain length of time for some input but has not received it. For example, computer programs often perform a time-out so the program does not set idle while waiting for an input that it may never receive. Automatic bank-teller machines often will perform a time-out if a necessary password is not entered quickly enough. The motivation to control computer time-outs has existed for many years. During a time-out, a computer can go into a screen saver mode.

Therefore, it is a principal object of the instant invention to provide an improved system and apparatus to control computer time-outs.

This and further and more specific objects and advantages of the invention will be apparent to those skilled in the art from the following detailed description thereof, taken in conjunction with the drawings, in which:

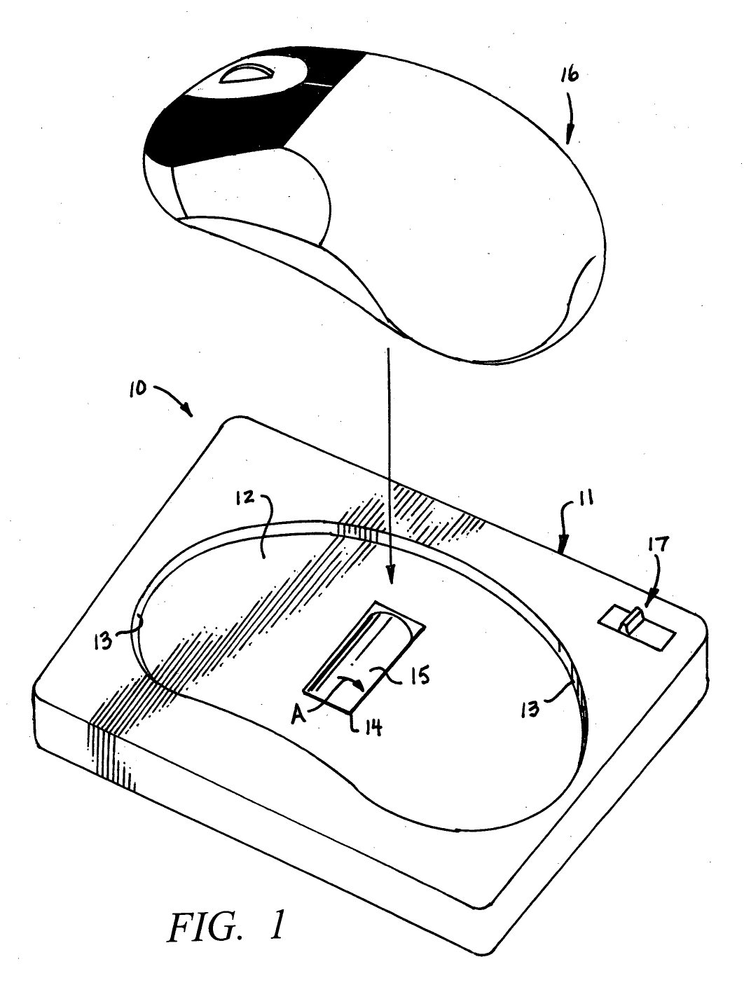

FIG. 1 is a perspective view illustrating a computer time-out control apparatus constructed in accordance with the invention;

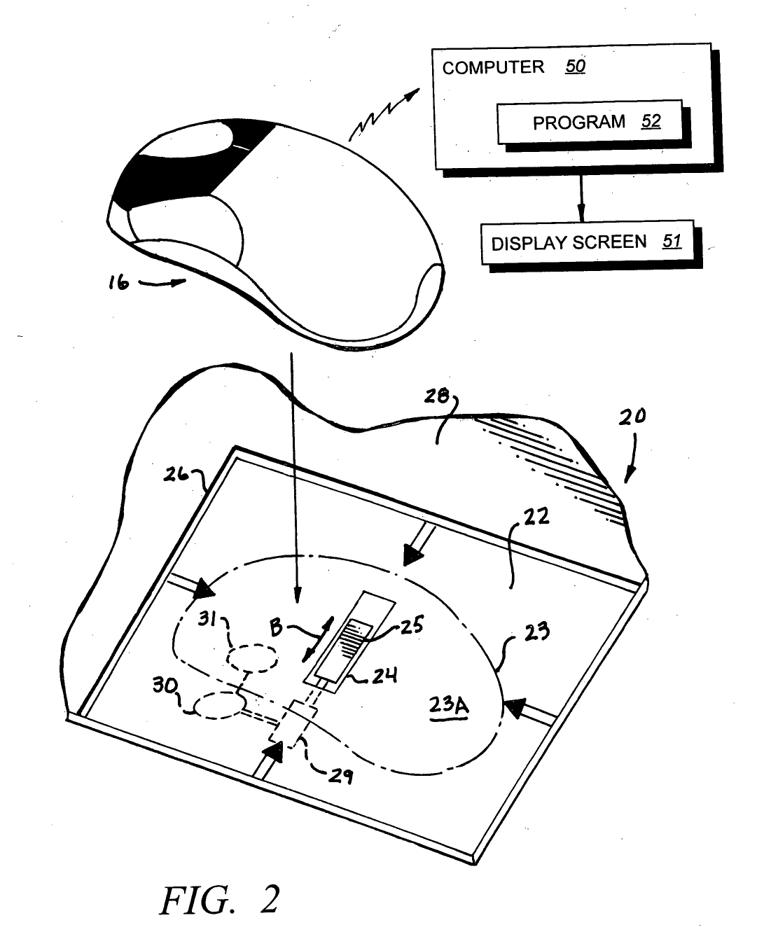

FIG. 2 is a perspective view illustrating an alternate embodiment of a computer time-out control apparatus constructed in accordance with the invention;

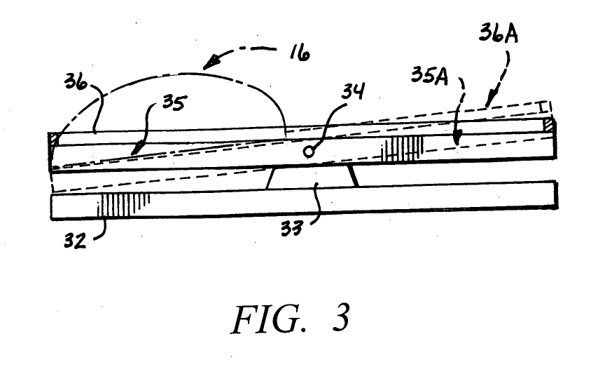

FIG. 3 is a side elevation view illustrating still another embodiment of the computer time-out control apparatus of the invention;

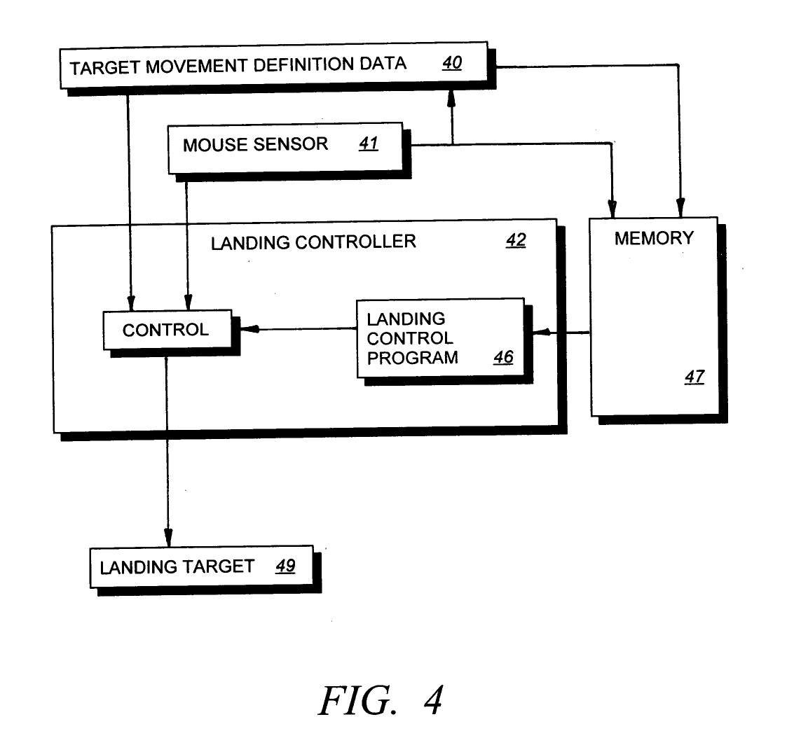

FIG. 4 is a block diagram illustrating a controller utilized in the practice of the invention;

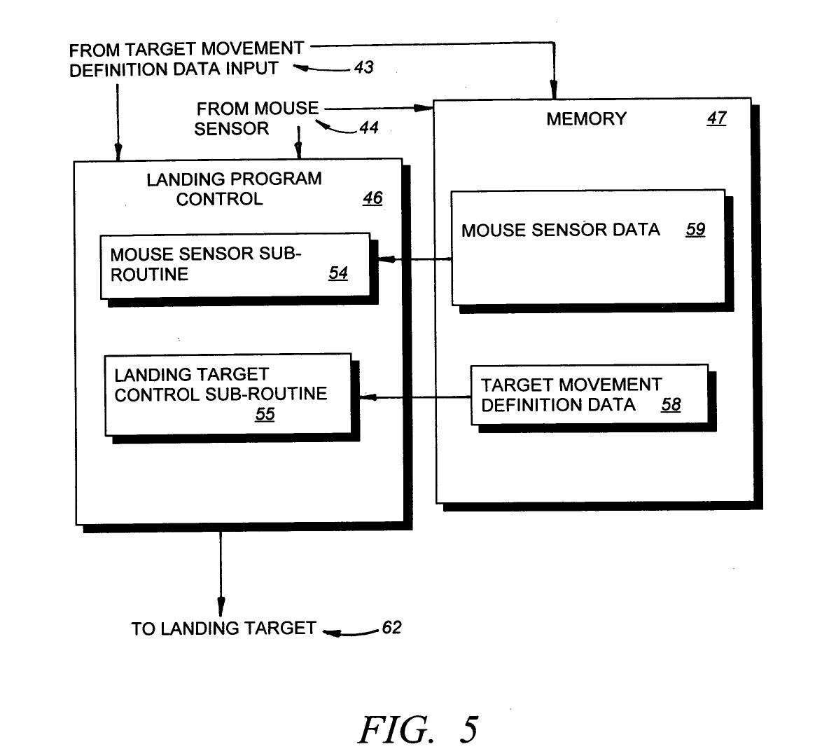

FIG. 5 is a block diagram illustrating sub-routines and memory data utilized in the controller of FIG. 4; and,

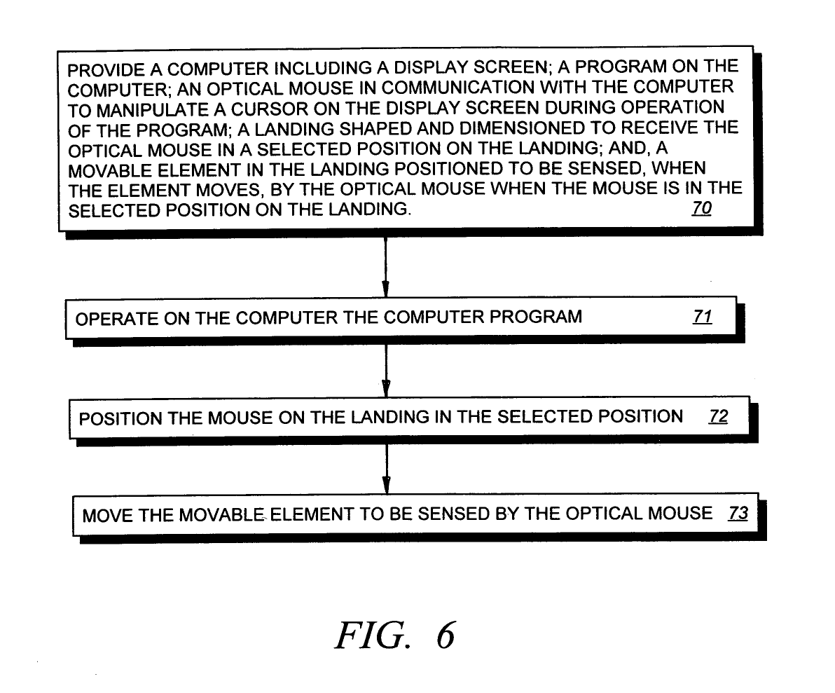

FIG. 6 is a block diagram illustrating a method in accordance with the invention.

Briefly, in accordance with the invention, provided is an improved method to control time-outs during a computer program. The method includes the step of providing a computer including a display screen; a program on the computer; an optical mouse in communication with the computer to manipulate a cursor on the display screen during operation of the program; a landing shaped and dimensioned to receive the optical mouse in a selected position on the landing; and, a movable element in the landing positioned to be sensed, when the element moves, by the optical mouse when the mouse is in the selected position on the landing. The method also includes the steps of operating on the computer the computer program; positioning the mouse on the landing in the selected position; and, moving the movable element to be sensed by the optical mouse.

Turning now to the drawings, which depict the presently preferred embodiments of the invention for the purpose of illustrating the practice thereof and not by way of limitation of the scope of the invention and in which like reference characters refer to corresponding elements throughout the several views, FIG. 1 illustrates an apparatus which is generally indicated by reference character 10 and is utilized to control time-outs during the utilization of a computer program. The computer program can comprise any program utilized on a computer. By way of example, and not limitation, the program can comprise an Internet web page which times-out while being utilized or downloaded; can comprise a game which is being played on the computer; can comprise a program utilized by a surgeon which undertaking surgery on a patient; can comprise a financial program being utilized on a computer; etc.

The apparatus 10 of FIG. 1 includes a base 11 with a landing 12 shaped and dimensioned to receive a computer mouse 16. Mouse 16 can be hard wired or be wireless, as desired. Mouse 16 presently preferably includes an optical sensor which detects when mouse 16 is moving over a mouse pad or other surface. Ledge, or wall, 13 extends around the perimeter of landing 12 and functions to retain mouse 16 in a selected position on landing 12 such that the optical sensor of mouse 16 is positioned directly over movable cylindrical target element 15. Target element 15 is rotatably housed in orthogonal opening 14 which extends downwardly into the landing 12 of base 11. Element 15 is rotatably powered in the direction of arrow A by a small motor or other prime mover (not visible) mounted in base 11. The motor is turned on and off with manually operated switch 17.

If desired, switch 17 can have more than two operative positions: a first operative “on” position, a second operative “off” position, and a third operative “intermittent” position. When switch 17 is in the “intermittent” position, the motor driving target element 15 turns on for selected limited periods of time at selected intervals. For example, the motor can run for two seconds, be off for ten seconds, run for two seconds, be off for another fifteen seconds, and so on.

FIG. 2 illustrates an alternate embodiment of the invention comprising a mouse pad generally identified by reference character 20. FIG. 2 illustrates a portion of mouse pad 20.

The remaining portion of pad 20 that is not illustrated in FIG. 2 is constructed in any desired fashion, but typically comprises a thin, flexible pad fabricated from a polymer material. The portion of pad 20 illustrated in FIG. 2 includes upper surface 28. Inscribed or imprinted or otherwise formed on surface 28 is line of demarcation 23 circumscribing and defining a landing 23A or selected area in which mouse 16 is placed when not in use. Perimeter lines 26 are also formed on surface 28 to bound the area in which landing 23A is found. When mouse 16 is set within line of demarcation 23 in the specific orientation illustrated in FIG. 2, the optical sensor of mouse 16 is positioned directly over movable thin panel target element 25. Target element 25 is oscillated back and forth in orthogonal opening 24 by a solenoid or other prime mover. Sensor. 31 detects when mouse 16 is positioned within line of demarcation 23. Sensor 31 can be a magnetic sensor and detect the present of iron in mouse 16, can be optical sensor, or can be any other desired sensor which detects when mouse 16 is setting on landing 23A within line of demarcation 32. Sensor 31 is embedded in or otherwise mounted in or on mouse pad 20. Sensor 31 generates signals which are transmitted to microprocessor 30 embedded in or otherwise mounted in or on mouse pad 20. In one preferred embodiment of the invention, sensor 31 (or 41), computer 30, and prime mover 29 are fully enclosed and integrated in pad 20 and are not visible. When sensor 31, 41 (FIG. 4) detects a mouse 16 setting on landing 23A and sends signals to microprocessor 30, microprocessor 30 activates prime mover 29 to oscillate element 25 in the direction of arrows B. Microprocessor 30 can be programmed to continuously or periodically, as desired, oscillate element 25 when mouse 16 is setting on landing 31. Alternately, a switch comparable to switch 17 can be mounted in mouse pad 20 and can be used to turn prime mover 29 on and off.

The embodiment of the invention illustrated in FIG. 3 includes a flat, rectangular base 32 and a “teeter—totter” landing 35 circumscribed by an upstanding wall or ledge 36. Landing 35 pivots about pin 34. Mouse 16 is placed on landing 35 and is caused to move by tilting landing 35 and ledge 36 like a teeter—totter in the manner suggested by dashed lines 35A and 36A, respectively. Tilting landing 35 causes mouse 16 to slide over the surface of landing 35. Landing 35 can be manually tilted or can be mechanically tilted with a prime mover.

FIG. 4 further illustrates a system of the type depicted in FIG. 2. Target movement definition data 40 defines the movement of a landing target 49, 25, 15. In FIG. 1, data 40 is defined and provided by the setting of switch 17. If switch 17 is moved to an “off” position, then movement of target 15 ceases or is not permitted. When switch 17 is moved to an “on” position, then movement of target is initiated and continues until switch 17 is moved back to the “off” position. It is also possible, as noted above, that when switch 17 is moved to an “on” position, the motor driving target 15 will be programmed to cause target 15 to move intermittently for selected periods of time.

In FIG. 2, target movement definition data 40 is provided by sensor 31. When microprocessor 30 does not receive signals from sensor 31 indicating that mouse 16 is setting on landing 23A, the microprocessor 30 does not activate prime mover 29. When microprocessor 30 does receive signals from sensor 31 indicating that mouse 16 is setting on landing 23A, microprocessor 30 activates prime mover 29 to continuously or intermittently oscillate target 25. Sensor 31 and microprocessor 30 together function, in essence, like a switch 17.

Microprocessor 30 is considered to provide a secondary kind of target movement definition data 40 because microprocessor 30 is programmed to cause target 25 to oscillate continuously or intermittently, as desired, when mouse 16 is setting on landing 23A. Similarly, in FIG. 1, the prime mover (not visible) powering target 15 can be programmed to continuously or intermittently drive target 15 and can therefore be considered also to provide a secondary kind of target movement data. Consequently, as used herein, target movement definition data 40 comprises any data which turns a landing target 15, 25, 49 on or off or which dictates how the landing target moves. How a landing target moves can include, by way of example and not limitation, how fast the target moves, whether the target moves continuously when a mouse 16 is on a landing 12 or 23A, whether the target moves intermittently when a mouse 16 is on a landing 12 or 23A, and how long the target moves and is stationary when the target is moving intermittently when a mouse 16 is on a landing 12 or 23A.

In FIG. 4, the mouse sensor is identified by reference character 41. Sensor 41 provides target movement definition data 40 to a microprocessor which includes a landing controller 42 and memory 47. A landing control program 46 in controller 42 receives target movement definition data 40 and determines when the microprocessor controller 42 sends to target 49 signals activating movement of the landing target 49.

Program 46 also determines how target 49 moves when activated. For example, program 46 can define how fast the target 15, 25, 49 moves, define whether the target moves continuously when a mouse 16 is on a landing 12 or 23A, define whether the target moves intermittently when a mouse 16 is on a landing 12 or 23A, and/or define how long the target moves and is stationary when the target is moving intermittently when a mouse 16 is on a landing 12 or 23A.

In FIG. 5, landing program control 46 includes mouse sensor sub-routine 54 and landing target control sub-routine 55. Sub-routine 54 processes target movement definition data 40 to determine whether a mouse 16 is setting on a landing 12 to 23A. Sub-routine 55 controls the movement of a landing target 49 by activating target 49 and determining how target 49 moves. Memory 47 includes mouse sensor data 59 (from a sensor 31, 41) and target movement definition data 58. Data 58 comprises data in memory 47 which defines how a target 49 moves when activated.

A methodology utilized in one embodiment of the invention is set forth in FIG. 6. In step 70, provided are a computer including a display screen; a program on the computer; an optical mouse in communication with the computer to manipulate a cursor on the display screen during operation of the program; a landing shaped and dimensioned to receive the optical mouse in a selected position on the landing; and, a movable element in the landing positioned to be sensed, when the element moves, by the optical mouse when the mouse is in the selected position on the landing. In step 71 the computer program is operated. In step 72 a mouse is positioned on the landing in the selected position. In step 73 the movable element is moved to be sense by the optical mouse. In one particular scenario in accordance with the invention, the apparatus of FIG. 1, 2 or 3 is utilized in conjunction with medical program 52 on a computer 50. The program 52 is utilized by a surgeon concurrently with surgery being performed on a patient. In use, the program 52 produces displays on screen 51 that are utilized by the surgeon during the surgery. The apparatus of FIG. 1, 2 or 3 prevents the program from timing out while a surgeon is temporarily engaged in a surgical procedure and is not using a mouse 16 to operate the program 52.

As would be appreciated by those of skill in the art, a time-out can occur during a program for more than one reason. If a program takes too long to download from the Internet, a web site dispensing or the computer receiving the program may time out. If a program is being operated on a computer and the computer does not detect movement of the cursor on the screen (i.e., does not detect movement of the mouse used to control the position of the cursor on the screen), the program may time out; when the program times out, the computer can, for example, fall into a screen saver mode. The system of the invention is specifically used to prevent time outs caused when a mouse is not moved during a period of time having a selected length. A program might, for example, time out after a mouse is not moved for ten seconds, or fifteen seconds, or thirty seconds, etc.

As would be appreciated by those of skill in the art, a light can be mounted on a target 15, 25. Further, the target 15, 25 can comprise a light mounted in a housing such that the housing (and therefore the light mounted in the housing) moves and such movement is detected by the optical sensor in mouse 16.

In another embodiment of the invention, target 15, 25 does not move but comprises a light which periodically turns on and off at selected time intervals. Mouse 16 includes a sensor which detects when the light turns on, or off, and which generates a signal to the associated computer 50 to cause the cursor on the display screen 51 to move to prevent a program from timing out. In each embodiment of the invention disclosed herein, the signal generated by the mouse 16 optical sensor or other sensor or component in mouse 16 need not actually cause the cursor on the display screen to move, but may be sufficient for the computer 50 to generate a signal that otherwise prevents a program from timing out. Further, the sensor in mouse 16 that detects movement of a target 15, 25 or detects the turning on or off of a light is not limited to being an optical sensor but can be any desired sensor or sensor system.

In a further embodiment of the invention, target 14, 25 does not move but comprises at least first and second LEDs or other light sources. Only one LED is on at any given time. When one LED turns off, the other turns on. This on—off operation occurs periodically at selected time intervals. Mouse 16 includes a sensor which detects when one light turns off and the other light turns on, and which generates a signal to the associated computer to cause the cursor on the display screen to move to prevent a program from timing out.

In still another embodiment of the invention, a target 15, 25 and prime mover 29 can be mounted in or on mouse 16. When target 15, 25 is activated, target 15, 25 moves or is otherwise energized such that the optical sensor or another sensor in mouse 16 detects the movement and causes the mouse 16 to produce a signal that causes the cursor on the display screen to move to prevent a program from timing out. The target 15, 25 can be activated—and deactivated—with a switch that is mounted on mouse 16 (or another location) and that is operatively associated with prime mover 29 to turn prime mover 29 (or another energy source) on and off.

In still a further embodiment of the invention, a mouse 16 includes a microprocessor which when activated produces a signal that causes the cursor on the display screen to move to prevent a program from timing out. The microprocessor can be activated—and deactivated—with a switch that is mounted on mouse 16 or at another location. This embodiment of the invention does not require a target 15 or 25, a prime mover, a sensor, etc.

In yet a further embodiment of the invention, the computer 50 includes a program which when activated produces a signal that prevents a program from timing out. The program can be activated by depressing appropriate keys on a keyboard operatively associated with computer 50 or can be activated by any other desired means.

Having described my invention in terms understandable to those of skill in the art, and having described the presently preferred embodiments and best mode thereof,

I claim:

1. A method to control time-outs during a computer program comprising the steps of
(a) providing
(i) a computer including a display screen,
(ii) a program on said computer,
(iii) an optical mouse in communication with said computer to manipulate a cursor on said display screen during operation of said program,
(iv) a landing shaped and dimensioned to receive said optical mouse in a selected position on said landing, and
(v) a movable element in said landing positioned to be sensed, when said element moves, by said optical mouse when said mouse is in said selected position on said landing;
(b) operating said computer program;
(c) positioning said mouse on said landing in said selected position; and,
(d) moving said movable element to be sensed by said optical mouse.
